(19) United States
(12) Patent Application Publication
(10) Pub. No.: US 2023/0027349 A1
(43) Pub. Date: Jan. 26, 2023

(54) SYSTEMS AND METHODS FOR PRIORITIZING TASKS IN AN INVENTORY

(71) Applicant: State Farm Mutual Automobile Insurance Company, Bloomington, IL (US)

(72) Inventor: Steven L Baird, Hudson, IL (US)

(21) Appl. No.: 17/869,358

(22) Filed: Jul. 20, 2022

Related U.S. Application Data
(60) Provisional application No. 63/223,609, filed on Jul. 20, 2021.

(51) Int. Cl. G06Q 40/08; G06Q 10/06; G06Q 30/02

(52) U.S. Cl. CPC G06Q 40/08; G06Q 10/0633; G06Q 30/0201

(57) ABSTRACT

A claim handler inventory prioritization system can assign priority to insurance claims. The system can employ multiple machine learning models to assign priority to insurance claims. Through training, machine learning models of the system can identify trends and/or patterns in claim information as a whole or individual claim elements such as service level obligation and claim lifecycle. Through application of machine learning models, the system can predict and/or determine different priorities and provide multiple graphical user interface views to a claim handler.

### CROSS-REFERENCE TO RELATED APPLICATIONS

This application is a Nonprovisional of and claims priority to U.S. Provisional Patent Application No. 63/223,609, filed on Jul. 20, 2021, the entire disclosure of which is hereby incorporated herein by reference.

### TECHNICAL FIELD

The present disclosure relates to the prioritization of tasks within an inventory, and in some examples, more particularly to prioritizing insurance claims for claim handlers and support staff (both, hereinafter, referred to as a “claim handler” or “claim handlers”) within an insurance company.

### BACKGROUND

Insurance companies typically have claim handlers who complete tasks associated with an insurance claim (e.g., to close the claim). Since an insurance company can provide multiple types of insurance to clients (auto, home, business, etc.), an insurance company may utilize a plurality of software applications and processes for claim handlers of different insurance groups and/or verticals. As such, in order to work on and close claims, different claim handlers will have to perform claim tasks using different software applications and workflow processes.

Insurance claims themselves may have an associated service level objective (SLO) and/or one or more associated times. More specifically, a SLO is an agreement an insurance company can make with its customers related to a service level agreement. For example, a SLO may include terms with which an insurance company is to comply with as it handles claims. In one non-limiting example, a SLO may require an insurance company to respond to a “high-priority” task within two business days, “medium-priority” tasks within five to seven business days, and “low-priority” tasks within thirty business days. In addition to a time-to-completion, claims may also have time related metrics associated with performing a certain task, such as a time remaining to completely close a claim, time to finish a specific task associated with the claim, or other similar time related metrics. Insurance claims can also be classified according to other factors. For instance, claim complexity, value of a claim, type of claim (car accident, house break-in, etc.), or similar types of data can be factors in determining how and/or when to process claims.

### SUMMARY

Described herein are systems and methods for determining claim priority for claim handlers. Claim information from a plurality of systems may be processed by a machine learning model to determine priority information associated with claims. The machine learning model may generate the priority information at least in part by being trained on training data associated with at least closed claims. The priority information may be displayed to a claim handler in different views of a user interface which may be defaulted for a specific claim handler.

According to a first aspect, a method can include obtaining, by a claim handler inventory prioritization system, claim information from a plurality of claim management systems. The method can also include generating using a supervised machine learning model, priority information for the insurance claim information, based on a set of training data, wherein the set of training data contains closed insurance claims, and the priority information is generated based on trends or patterns identified within the set of training data during machine learning training. The method can also include displaying, via a display, the insurance claim information and the priority information.

According to a second aspect, a computer system can comprise one or more processors and memory storing computer-executable instructions that, when executed by the one or more processors, cause the computing system to perform operations. The operations can include obtaining, by a claim handler inventory prioritization system, claim information from a plurality of claim management systems. The operations can also include generating using a supervised machine learning model, priority information for the insurance claim information, based on a set of training data, wherein the set of training data contains closed insurance claims, and the priority information is generated based on trends or patterns identified within the set of training data during machine learning training. The operations can also include displaying, via a display, the insurance claim information and the priority information.

According a third aspect, one or more non-transitory computer-readable media can store computer-executable instructions that, when executed by one or more processors, cause the one or more processors to perform operations. The operations can include obtaining, by a claim handler inventory prioritization system, claim information from a plurality of claim management systems. The operations can also include generating using a supervised machine learning model and or business rule priority information for the insurance claim information, based on a set of training data, wherein the set of training data contains closed insurance claims, and the priority information is generated based on trends or patterns identified within the set of training data during machine learning training. The operations can also include displaying, via a display, the insurance claim information and the priority information.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 shows an example system for prioritizing tasks, according to an example of this disclosure.

FIG. 2 shows an example prediction graph and example data fields, illustrating example implementations of this disclosure.

FIG. 3 shows an example of a graphical user interface associated with a system for prioritizing tasks, according to examples of this disclosure.

FIG. 4 shows an example of another graphical user interface associated with a system for prioritizing tasks, according to examples of this disclosure.

FIG. 5 shows an example of another graphical user interface associated with a system for prioritizing tasks, according to examples of this disclosure.

FIG. 6 shows an example of another graphical user interface associated with a system for prioritizing tasks, according to examples of this disclosure.

FIG. 7 shows an example flowchart illustrating an example process for training a system to prioritize tasks, according to examples of this disclosure.

FIG. 8 is a block diagram illustrating an example computing system architecture for implementing task prioritization according to aspects of this disclosure.

### DETAILED DESCRIPTION

An insurance company can have numerous claim handlers, representatives, associates, and/or other individuals who can perform one or more tasks associated with processing an insurance claim. Some example tasks can include determining insurance policy coverage, determining liability, determining damage amounts, and/or performing other actions.

Insurance claims may vary in complexity. For example, when a driver backs a car out of a residential garage and a side mirror of the car hits the side of the garage, an insurance claim for damage to the side mirror may be relatively simple, because the claim involves only one insured individual (e.g., the driver/homeowner) and one car. However, another insurance claim associated with a multiple-car accident at a busy intersection may be relatively complex, because the claim may involve multiple participants, multiple vehicles, multiple insurance policies, and/or other complicating factors.

An insurance claim submitted to an insurance company may be assigned to one of many individuals or groups of individuals within the insurance company, based at least in part on the complexity of the claim. For example, and as discussed above, the SLO may provide criteria for determining an associated complexity. For example, the insurance company, using the SLO, can divide claim handlers and other workers into different groups, segments, or tiers that correspond to different claim complexity levels, different claim types, and/or other claim attributes.

Conventionally, claim handlers work on insurance claims through a reactive process where they focus on certain claim factors over others instead of looking at claims, and all claim factors, holistically, before selecting what claim to work on next. This is partly due to the SLO assigned to the individual claims tasks that each claim handler works on. For example, a claim handler may only work on “high priority” SLO claim tasks which are due in two days but then not address any “low priority” SLO claims tasks during that time period. The result in this example is that while “high priority” SLO claims tasks are handled in time the “low priority” SLO claims tasks may be delayed or completed late. As such, some claim handlers may refer only to the SLO and decide which claim tasks to work on next without looking at the other claim factors holistically.

Certain types of insurance claims may have multiple associated tasks, sometimes referred to as lifecycle tasks. These types of tasks may be segmented into different phases such as, but not limited to, an investigation phase, an evaluation phase, or a negotiation phase. The investigation phase may involve actions and/or tasks that need to be accomplished before a liability decision can be made as to which party, or parties, bears the responsibility of liability. The evaluation phase may involve actions and/or tasks aimed at determining the extent of the injury, e.g., personal injury, property damage, or the like. The negotiation phase may involve actions and/or tasks in ensuring that a party offered a settlement either takes the amount offered or takes a negotiated amount starting from the amount offered. Some claim handlers may choose to work on claims by looking at only the lifecycle phase they are in, disregarding other claim factors outside of lifecycle, and as such, are not acting proactively to look at claims holistically. This also results in claim handlers not proactively prioritizing all their claims. As a practical result, many claim handlers pick and choose the claims they deem appropriate and/or interesting.

In some instances, some claim handlers may focus only on replying to messages associated with existing claims. For example, insurance claims may have associated messages, such as telephone voicemails, email messages, text-based messages, or the like. Such messages are often addressed to the claim handler assigned to the claim. However, claim handlers who focus on only answering and responding to messages may fail to look at the SLO and/or deadlines associated with existing claims. As will be appreciated, failure to consider all relevant claim factors leads to improper prioritization, which can result in failure to timely complete tasks associated with a claim and/or, ultimately, a failure to completely close claims timely.

At many insurance companies, there may be as many as 15,000 lifecycle tasks pending and 60,000 claims pending in total, at any one time. Unfortunately, insurance claims and their tasks are not autonomously or semi-autonomously prioritized so that claim handlers can proactively manage their claim inventory, all within one system. Claim handlers currently have to use a plurality of systems and reports to perform tasks to close claims. Thus, claim handlers have to unilaterally manage understanding all the factors of claims such as each claim's SLO and lifecycle phase and are not able to holistically prioritize their claims in an efficient manner. This causes delays in claim processing and unhappy parties who are awaiting the resolution of claims.

The systems and methods described herein can implement one or more machine learning models to prioritize tasks associated with closing insurance claims, e.g., relative to other tasks. In some examples, machine learning models may be applied to a claim as a whole or to individual claim elements to identify trends and/or patterns through machine learning training. Once training is complete, machine learning models may be applied to make predictions and/or determinations concerning claim/task priority. The priorities associated with claims and tasks are used to suggest what claims and/or tasks should be worked on before others. The systems described herein can also generate user interfaces for display to claim handlers.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

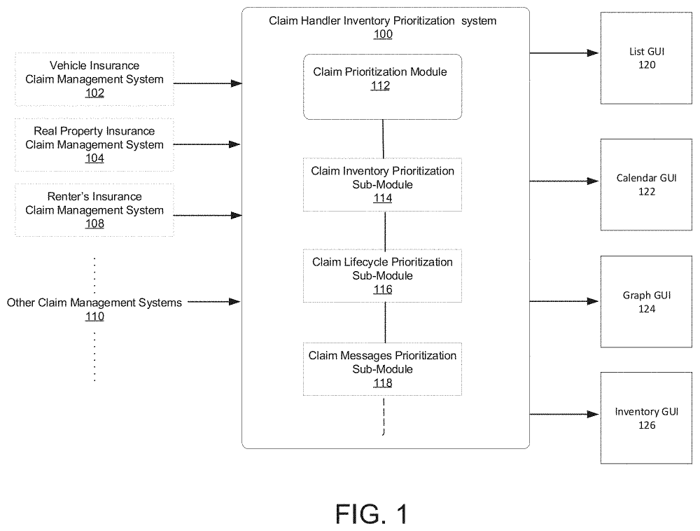

FIG. 1 shows an example of a system 100 for prioritizing tasks in an inventory, such as tasks associated with processing insurance claims. The system 100 receives, retrieves, or otherwise obtains claim information from a plurality of claim managements systems. FIG. 1 illustrates examples of a vehicle insurance claim management system 102 (related to vehicle insurance claims), a real property insurance claim management system 104 (related to real property insurance claims), a renter's insurance claim management system 108 (related to rental property insurance claims), and other claim management systems 110 (e.g., related to other types of insurance claims such as death or disability insurance claims, business insurance claims, or cyber security claims). More specifically, the vehicle insurance claim management system 102 may provide to the system 100 claim information involving vehicle accidents, vehicle damage, or the like. Such claim information can include details about an accident that is the subject of a claim, details about one or more dates associated with the claim, e.g., when the claim was initiated, the date of the accident, or the like, and/or information identifying the claim handler assigned to the claim. The real property insurance claim management system 104 may provide to the system 100 claim information involving weather damage to an insured's house or any other property damage, details about one or more dates associated with the claim, e.g., when the claim was initiated, the date of the damage, dates associated with aspects of processing the claim, along with the claim handler assigned to the claim. The renter's insurance claim management system 108 may provide to the system 100 claim information involving damage to an insured's rental property, details about one or more dates associated with the claim, e.g., when the claim was initiated, the date of the damage, dates associated with aspects of processing the claim, along with the claim handler assigned to the claim. Other claim management systems 110 may deliver to the system 100 any other claim information which a claim handler may be assigned, for example, claim information related to business insurance or cyber risk insurance, and the claim handlers assigned to those claims.

In non-limiting examples, the system 100 receives claim information from the claim management systems and prioritizes claims for processing, e.g., by an appropriate claim handler. More specifically, the system 100 uses a claim prioritization module 112 to prioritize the received claim for the claim handler assigned to the claim. The claim prioritization module 112 may be implemented as multiple sub modules, e.g., to prioritize claims via analysis of different claim information. As shown in FIG. 1, the system 100 can include a claim inventory prioritization sub-module 114, a claim lifecycle prioritization sub-module 116, a claim messages prioritization sub-module 118, and/or any other sub modules and/or programmatic procedures which would be applicable to assist in prioritizing claims for claim handlers within at least system 100.

The claim prioritization module 112 may incorporate one or more machine learning models and/or other prediction algorithms that may be trained using supervised or unsupervised machine learning techniques. The claim prioritization module 112 may employ a neural network, which may be a convolutional neural network, a deep learning neural network, or any other suitable network. The claim prioritization module 112 may also employ other types of machine learning models and/or programs such as support vector machines, expert systems, Bayesian belief networks, fuzzy logic, data fusion engines, classifiers, and/or any logistic regression type of machine learning. Machine learning, as employed by the claim prioritization module 112, may involve identifying and recognizing patterns in closed and/or completely processed claim information in order to facilitate making predictions and/or determinations. Models may be created based upon processed and closed claim information in order to make valid and reliable predictions and/or determinations based off of patterns and/or trends of closed claims. The training data that feeds the machine learning models and/or programs used by the claim prioritization module 112 may be consistently updated such that the predictions and/or determinations are more accurate over time, or that the predictions and/or determinations change concurrently as the data which feeds the machine learning algorithm(s) changes.

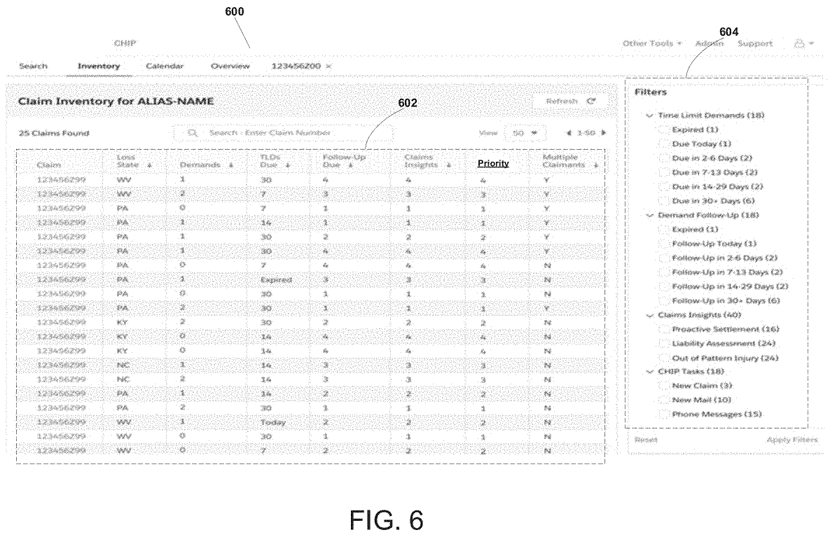

In some non-limiting examples, the claim prioritization module 112 may utilize claim inventory prioritization sub-module 114 to prioritize claims at an inventory level. An inventory level of claims, as shown later in detail in FIG. 6, is a holistic view of all claims a claim handler has assigned to her at that certain moment in time. As such, the claim handler can pick any of the claims assigned to her from her inventory by not only utilizing existing claim information such as the insured's policy number, coverage information, date of loss, and parties involved, but also a predicted priority of the claim, as a whole. Thus, claim inventory prioritization sub-module 114 may apply a machine learning model, and/or models, to claim information, in order to predict and/or determine a claim priority for a single claim in the claim handler's inventory.

Claim inventory prediction may involve claim inventory prioritization sub-module 114 being trained with a training set of either only the claims assigned to the claim handler, the claims assigned to the claim handler's team, the claims assigned to the insurance company that the claim handler works for, or any combination. Other sources of claim information (e.g., insurance industry information) which may be useful for claim inventory priority prediction and/or determination during training of the training set, may also be used. For instance, in supervised machine learning, claim inventory prioritization sub-module 114 may train a training set consisting of only the processed and closed claims assigned to the claim handler. Over time, the pattern and/or trends of how the claim handler processes and completes claims may change. These patterns and/or trends may be used to predict an average or mean amount of time (months/days/hours etc.) a claim handler needs to complete a high, medium, or low priority SLO claim. For example, some processed and closed claim data of the claim handler may reflect that the claim handler on average completes a high priority SLO claim in three days. In this example, a prediction and/or determination can be made that this particular claim handler will on average close a high priority SLO claim in three days. However, as time passes and more processed and closed claim information of the claim handler is collected and analyzed, such patterns and/or trends may change. For example, analyzing a set of processed and closed claim information of the claim handler may reflect that the claim handler now takes on average two days to close a high priority SLO claim, as such, a prediction can be made that this particular claim handler now requires only two days to close a high priority SLO claim.

In another non-limiting example, in supervised machine learning, the claim inventory prioritization sub-module 114 may train a training set consisting of the processed and closed claims assigned to the claim handler's team. For example, if the claim handler is assigned to a claim handling team that only works on automobile insurance claims, then the claim inventory prioritization sub-module 114 will only look at the team's processed and closed automobile insurance claims for prediction and/or determining priority of the claim handling team's claims. Similar to the above example, over time, the pattern and/or trends of how the claim handler's team processes and completes claims may change. These patterns and/or trends may be used to predict an average or mean amount of time (months/days/hours etc.) a claim handler team needs to complete any type of insurance claim. For example, some processed and closed claim data of the claim handler's team may reflect that the claim handler's team, on average, completes and processes their automobile claims in ten days, as such, a prediction and/or determination can be made that this particular claim handling team will on average close and process their automobile claims in ten days. However, as time passes and more processed and closed claim information of the claim handler's team is collected and analyzed, such patterns and/or trends may change. For example, some processed and closed claim information of the claim handler's team may reflect that such team now takes on average thirteen days to close automobile claims, as such, a prediction can be made that this particular claim handling team now requires thirteen days to close automobile claims.

In an additional example, in supervised machine learning, the claim inventory prioritization sub-module 114 may train a training set including already-processed and/or closed claims of the claim handler's insurance company. For example, if the claim handler is part of an insurance company with three hundred claim handlers, then the claim inventory prioritization sub-module 114 will look at the processed and closed claims of all the three hundred claim handlers to make a prediction and/or a determination on priority for unprocessed and/or unclosed claims. Similar to the above examples, over time, the patterns and/or trends of how the insurance company's claim handlers process and close claims may change. These patterns and/or trends may be used to predict an average or mean amount of time (months/days/hours etc.) all claim handlers of an insurance company needs to complete any type of insurance claim. For example, some processed and closed claim data of the insurance company's claim handlers may reflect that all claim handlers, on average, complete and process their low severity SLO claim in twenty-five days (high or medium severity SLO claims can be substituted for prediction). Accordingly, a prediction and/or determination can be made that an average claim handler of the insurance company will on average close a low severity SLO claim in twenty-five days. However, as time passes and more processed and closed claim information of the insurance company's claim handlers are collected and analyzed, such patterns and/or trends may change. For example, some processed and closed claim information of the insurance company's claim handlers may reflect that the insurance company's claim handlers now take on average thirty-six days to close a low severity SLO claim, as such, a prediction can be made that an average claim handler of the insurance company will take thirty-six days to close a low severity SLO claim.

The claim inventory prioritization sub-module 114 can also train and apply a machine learning model to predict and/or determine priority of claims using other techniques. For example, claim information from an insurance industry (e.g., auto, property and casualty, life insurance, etc.) in general may be collected, analyzed, and then added to a machine learning training set to first train a machine learning model. Once the training set is used to train the machine learning model, the trained machine learning model can be applied to make predictions and/or determinations via a machine learning prediction algorithm similar to the other examples above. These patterns and/or trends may be used to predict an average or mean amount of time (months/days/hours etc.) that claim handlers of a certain insurance industry needs to complete any type of insurance claim. For example, after training, a machine learning model evaluating insurance industry claim data may reflect that real property claims in the Northeast region of the United States, on average, take thirty-two days to complete. As such, a prediction can be made based off of this version of the trained training set, that real property claims in the Northeast region of the United States, on average, take thirty-two days to complete, and then applied to predict a priority of a claim.

In some examples, the claim prioritization module 112 may utilize the claim lifecycle prioritization sub-module 116 to prioritize lifecycle tasks within claims. For example, certain automobile insurance claims may have an investigative phase, an evaluation phase, a negotiation phase, and/or other phases that are required to be finished in order for an automobile claim to be designated as closed, in other words, not requiring any more action on the claim handler's part. As described above, the evaluation phase may signify that an automobile insurance claim is in an open status (i.e., not closed or complete) and liability has not been decided on and/or determined for the insurance company's insured and/or for other parties involved in the claim. During the evaluation phase, liability may have been determined and the injury to person and/or damage to property is to be determined. The negotiation phase may entail an offer of settlement to an injured or damaged property, and if accepted, the claim may be marked as complete. As noted above, there may be other phases and/or actions that are not a part of the investigation, evaluation, or negotiation phase. For instance, claims which have been closed without pay, or paid, and continue to have property that is pending to be salvaged and thus may not directly fall into the investigation, evaluation, or negotiation phase.

In another non-limiting example, the claim lifecycle prioritization sub-module 116 may utilize machine learning models to have a training set track the trends and/or patterns (through training) in the investigation phase, evaluation phase, the negotiation phase, or a combination thereof. These patterns and/or trends may be used to predict an average or mean amount of time (months/days/hours etc.) needed to complete a certain phase when taking into account certain factors such as loss date, claim status, state of loss, facts of the case, and policy coverages in force (and any other factors discussed in this disclosure). For instance, during the investigation phase, a machine learning model of the claim lifecycle prioritization sub-module 114 may be trained to identify that when there is stoplight video of an automobile accident along with eyewitnesses and a police report, the predicted length of the investigation phase is one day on average versus three days without any of the foregoing data. When the machine learning model is applied with this version of the training set with similar input data, the machine learning model will predict and/or determine that a claim handler should only take one day to complete the investigation phase and determine liability. In other words, the one-day prediction and/or determination will be made if the claim information has recorded video, eyewitnesses, and a police report, but a prediction and/or determination of three days without any (or all) of this information.

This prediction and/or determination can be utilized to inform the claim handler through a graphical user interface of the system 100 that a particular claim should require only one day to finish the investigation phase because there is a video, eyewitnesses, and a police report. Moreover, this prediction and/or determination can also be utilized to assign a priority number, different from other claims without the same parameters, to the investigation lifecycle phase to alert the claim handler that this particular claim should be looked at before others with different claim parameters, since such claim has features associated with it that could quickly advance the lifecycle of the claim versus others. Conversely, if such claim parameters were not present, then a lower priority may be set informing the claim handler that other claims in the same phase should be worked on before this particular one.

In yet another non-limiting example, patterns and/or trends may be used to predict an average or mean amount of time (months/days/hours etc.) needed to complete a certain phase when taking into account certain factors such as liability determination, medical evaluation, types of medical claims, policy limits, lost wages, and severity of injuries (and any other factors discussed in this disclosure). For example, during the evaluation phase, a machine learning model of the claim lifecycle prioritization sub-module 114 may be trained to identify that for an automobile accident claim resulting in personal injury, if the injured party visits a doctor for a medical evaluation within three days of the accident, the length of evaluation phase is less than two weeks. In contrast, the length of the evaluation phase is more than two weeks on average if the injured party visits a doctor more than three days after the accident. As such, when the machine learning model is applied with this version of the training set and similar input data, the machine learning model will predict and/or determine that a claim handler should complete the evaluation phase in less than two weeks if the injured party visits a doctor for a medical evaluation within three days of the accident, and more than two weeks otherwise.

This prediction and/or determination can be utilized to inform the claim handler through a graphical user interface generated by the system 100 that a particular claim should require less than two weeks to finish the evaluation phase if the injured party visits a doctor within three days of the automobile accident. Moreover, this prediction and/or determination can also be utilized to assign a priority number, different from other claims without the same parameters, to the evaluation lifecycle phase to alert the claim handler that this particular claim should be looked at before others with different claim parameters, since such claim has features that could quickly advance the lifecycle of the claim versus others. Conversely, if such claim parameters were not present, then a lower priority may be set informing the claim handler that other claims in the same phase should be worked on before this particular one.

In yet another non-limiting example, patterns and/or trends may be used to predict an average or mean amount of time (months/days/hours etc.) needed to complete a certain phase when taking into account certain factors such as number of phone call negotiations within a period of time, types of medical claims, liability determination (and any other factors discussed in this disclosure). For example, during the lifecycle negotiation phase, a machine learning model of the claim lifecycle prioritization sub-module 114 may be trained to identify that claim handlers who offer a settlement and have at least two phone calls within one week of the offer to follow up and negotiate have an 80% chance of having the offer accepted, and only a 55% chance of having the offer accepted if there are less than two phone calls within one week of the offer. As such, when the machine learning model is applied with this version of the training set with similar input data, the machine learning model will predict and/or determine that a claim handler should typically have at least two phone calls within the first week of the settlement offer, since not doing so would increase the likelihood that the offer is not accepted and prolong the claim lifecycle.

This prediction and/or determination can be utilized to inform the claim handler through a graphical user interface of system 100 that any claim with an offer pending should be followed up with at least two phone calls within the first week of the offer to the party which the offer was extended. Moreover, this prediction and/or determination can also be utilized to assign a priority number, for example, a priority number of a claim in the negotiation phase which may be higher if there were at least two phone calls within the first week of settlement, notifying the claim handler through the system 100 that such claim should be focused on over others with lower priority since such claim is more likely to be closed than other claims with lower priority. Conversely, if such claim parameters were not present, then a lower priority may be set informing the claim handler that other claims in the same phase should be worked on before this particular one.

In some non-limiting examples, the claim prioritization module 112 may utilize the claim messages prioritization sub-module 118 to prioritize messages for the claim handler to work on or utilize patterns and/or trends of messages in order to assist a claim handler in closing a claim. These patterns and/or trends and trends may evaluate message factors such as type of message (email, voicemail, text, etc.) and length of time a message has been left unanswered or replied to (e.g., didn't answer email concerning a claim for 5 days). As described above, a claim handler may have phone and email messages that are addressed to the claim handler concerning a claim that is not closed. For example, an insured claiming business loss may have both emailed and called (leaving a voicemail) the claim handler concerning the status of the claim. In another example, the claim handler may have phone messages or emails from colleagues concerning the progress of a claim or information concerning a claim which would be helpful to the claim handler to move forward a claim to being closed.

For instance, the claim messages prioritization sub-module 118 may be a machine learning model that is trained and identifies after training that a claim handler who responds to phone and email messages within one day usually closes a claim five days quicker than if she responds to the phone and email messages after a day of receipt of such messages. As such, when the machine learning model is applied with this version of the training set with similar input data, the machine learning model will predict and/or determine that a claim handler should, on a regular basis, respond to phone and email messages within one day of receipt.

This prediction and/or determination can be utilized to inform the claim handler through a graphical user interface of the system 100 that a particular claim with phone and/or email messages pending should be evaluated within one day of receipt or run the risk of having the claim close five days longer which was identified as a pattern and/or trend of the applied machine learning model. Moreover, this prediction and/or determination can also be utilized to assign an opportunity flag to phone and/or email messages that have been received within one day and can still be worked on in that day. In that way the claim handler may be able to quickly identify from a list of phone and/or email messages, the ones that have an opportunity to be evaluated within the same day of receipt and other messages that have lost that opportunity.

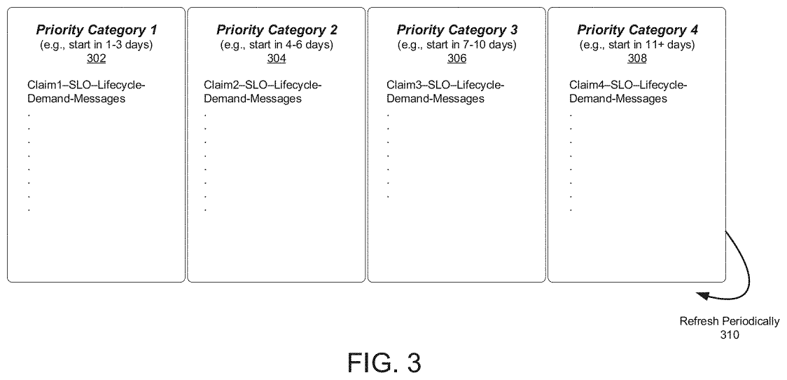

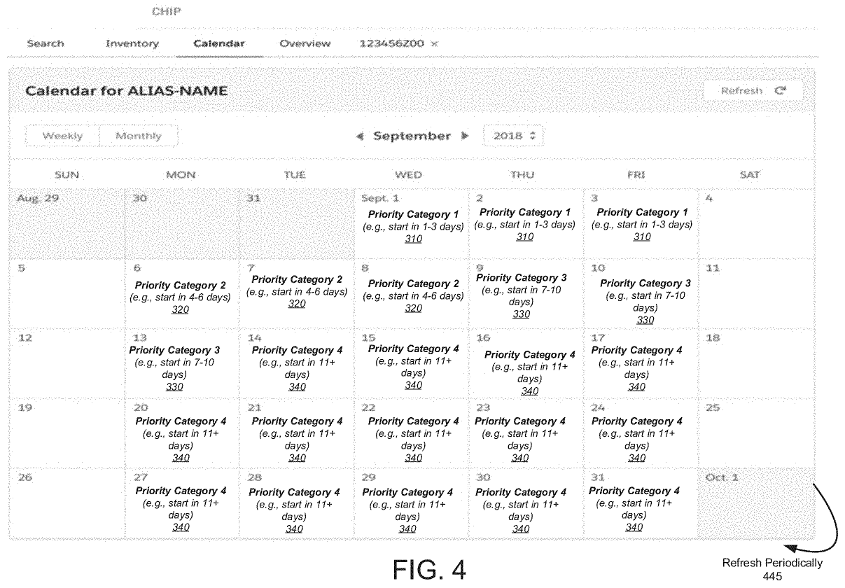

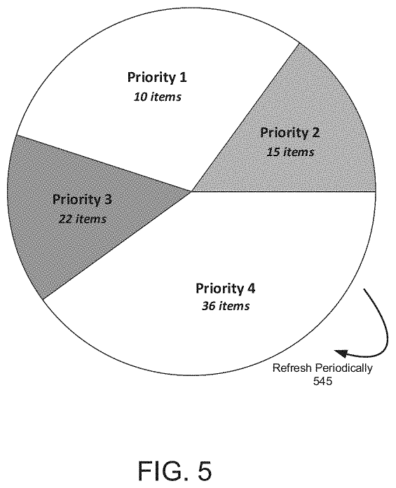

Once the claims are prioritized, possibly through machine learning methods and programs, such claims may be displayed to a claim handler via different graphical user interfaces. As shown in FIG. 1, there is a list GUI 120, a calendar GUI 122, a graph GUI 124, and an inventory GUI 126. The list GUI 120 may present prioritized claims in a list form as shown in FIG. 3. The calendar GUI 122 may present prioritized claims in graphical form as shown in FIG. 4. The graph GUI 124 may present prioritized claims in a graph form as shown in FIG. 5. The inventory GUI 126 may present prioritized claims in an inventory form as shown in FIG. 6.

As described above, although individual operations of one or more methods are illustrated and described as separate operations, one or more of the individual operations may be performed concurrently, and nothing requires that the operations be performed in the order illustrated. Structures, functionality, and factors presented as separate components in example configurations may be implemented as a combined structure or component. Similarly, structures and functionality presented as a single component may be implemented as separate components. These and other variations, modifications, additions, and improvements fall within the scope of the subject matter herein.

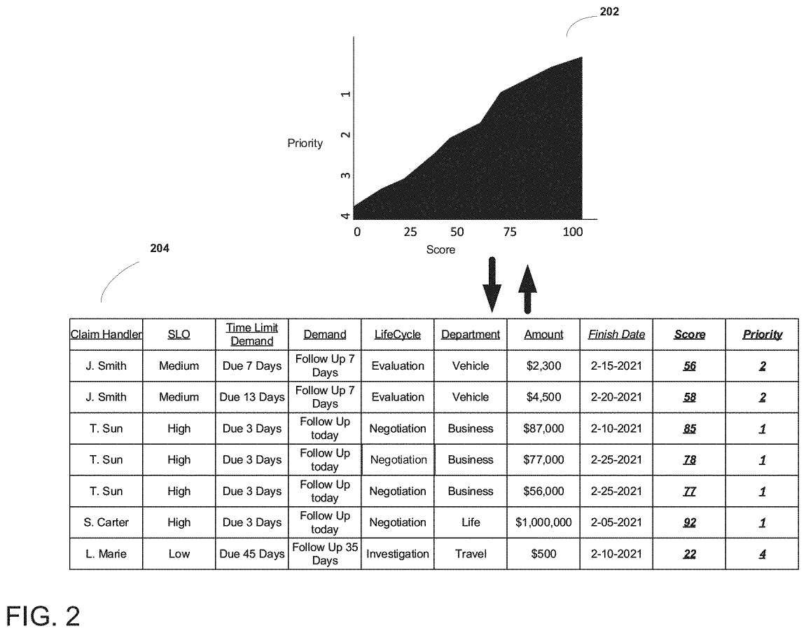

FIG. 2 shows a non-limiting example of a prediction graph and example data fields that can be used by the system 100. The claim prioritization module 112 may apply a trained machine learning module to create the prediction graph 202, as shown in FIG. 2. Prediction graph 202 may have a horizontal axis of a score that correlates to a vertical axis of priority. As shown in FIG. 2, prediction graph 202 may have four priority numbers to assign to a claim, individual claim elements, or a combination thereof. The four priority numbers are shown on the vertical priority axis. Prediction graph 202 may also have score numbers ranging from 0-100, on the horizontal score axis, that is directly correlated to the four priority numbers on the vertical axis. In the example shown in FIG. 2, if claim prioritization module 112, or one of its sub modules, utilizes a machine learning model and determines that a score is between 0-25, it will be predicted that the priority is 4, the lowest priority in this example. If claim prioritization module, or one of its sub modules, utilizes a machine learning model and determines that a score is between 26-50, it will be predicted that the priority is 3, the second lowest priority in this example. If claim prioritization module 112, or one of its sub modules, utilizes a machine learning model and determines that a score is between 51-75, it will be predicted that the priority is 2, the second highest priority in this example. Lastly, if claim prioritization module 112, or one of its sub modules, utilizes a machine learning model and determines that a score is between 76-100, it will be predicted that the priority is 1, the highest priority in this example.

Claim fields 204 are example fields that may be used by a machine learning model of claim prioritization module 112, and/or its submodules, to create the prediction graph 202, but these fields are not limiting. Additionally, claim fields 204 may store the prediction calculated by a machine learning model, here, in this non-limiting example, in the field name “priority.” For instance, claim prioritization module 112, and/or its submodules, may utilize all the fields shown in claim fields 204, except for priority (which is predicted by a machine learning model), to first train a machine learning model, and then to apply a machine learning model to predict and/or determine a score which directly correlates to a priority number ranking.

Specifically, as shown in claim fields 204, fields such as time limit demand, SLO, lifecycle, department, and amount may be used create a machine learning training set of claim prioritization module 112, and/or its submodules. This training set may be trained utilizing any machine learning techniques (some which are described herein or otherwise known within the art) to accurately predict claim priorities, claim element priorities, or priorities for a combination thereof. During training, the machine learning model of claim prioritization module 112, and/or its submodules, may determine trends and/or patterns of specific field attributes and create a score which correlates to a priority. Other fields that could be used (not shown) are name of the insured, date of loss, and follow up. The name of the insured may be the name of the person who is filing an insurance claim. The date of the loss may refer to the date when the event that caused the damage or loss occurred associated with a claim. Follow up may be an indicator to the claim handler as to whether they need to follow up with a person or entity to close a claim.

As a non-limiting example, during machine learning training, as shown in claim fields 204—a SLO of medium, a demand of following up in seven days, an amount between $2,000 and $5,000, a lifecycle phase of evaluation, and being a vehicle/automobile claim—may be given a score of between 51-75, which according to prediction graph 202, would equate to a priority of 2, for that specific automobile claim, or its claim elements. As such, after being trained, a machine learning model of claim prioritization module 112, and/or its submodules, may predict and/or determine a priority of 2, when a claim has a SLO of medium, a demand of following up in seven days, an amount between $2,000 and $5,000, a lifecycle phase of evaluation, and is a vehicle/automobile claim.

Also, during machine learning training, as shown in claim fields 204—a SLO of high, a demand of following up in three days, an amount between $50,000 and $100,000, a lifecycle phase of negotiation, and being a business or life insurance claim—may be given a score of between 76-100, which according to prediction graph 202, would equate to a priority of 1, for that specific business insurance claim, or its claim elements. As such, after being trained, a machine learning model of claim prioritization module 112, and/or its submodules, may predict and/or determine a priority of 1, when a claim has a SLO of high, a demand of following up in three days, an amount between $50,000 and $100,000, a lifecycle phase of negotiation, and is a business or life insurance claim.

In another non-limiting example, during machine learning training, as shown in claim fields 204—a SLO of low, a demand of following up in forty-five days, an amount between $0 and $1,000, a lifecycle phase of investigation, and being a travel insurance claim—may be given a score of between 0-25, which according to prediction graph 202, would equate to a priority of 4, for that specific business insurance claim, or its claim elements. As such, after being trained, a machine learning model of claim prioritization learning machine learning module 112, and/or its submodules, may predict and/or determine a priority of 4, when a claim has a SLO of low, a demand of following up in forty five days, an amount between $0 and $1,000, a lifecycle phase of investigation, and is a travel insurance claim.

In yet another non-limiting example, any fields which are associated with a pending claim may be used to assign priority. The system 100 may track how long a claim has been pending and has not been closed. A claim may have a SLO of low but could have been pending for sixty days. As such, a machine learning model of claim prioritization module 112, and/or its submodules, may be trained to identify these types of claims which have not been worked on for a substantial period of time, and assign them a higher priority ranking, and/or bring attention to these claims, even though, for instance, the severity of such claim may be low, and not high.

FIGS. 3-6 illustrate different claim views that claims can be provided to a claim handler to work on after claims have been prioritized by the claim handler inventory prioritization system 100. A list view, calendar view, graph view, or inventory view may be defaulted to a claim handler based on a claim handler's efficiency using each view. For example, a certain view may be defaulted based on the number of claims a claim handler closes in a certain view over a period of time (month/week/hour, etc.) or based on any of the factors discussed in this disclosure (SLO, time limit demand, lifecycle, department, etc.). As another example, a view (as shown in FIGS. 3-6) may be defaulted based on the amount of time a claim handler uses a certain view (e.g., the view which has the highest time usage within a period of time).

Additionally, the defaulted view may be based on the score or the priority described in FIG. 2. The defaulted view may be based on a priority number assigned to the majority of claims a claim handler works on, where the system 100 may determine that certain views are more efficient for use with certain priority numbered claims. As an example, if a claim handler works on priority number 2 claims 60% of the time, the system 100 may determine that a list view should be defaulted for the claim handler because other claim handlers who work on priority number 2 claims, on average, complete claims faster when using that view. As stated above, the defaulted view may be based on any factors or concepts described in this disclosure.

FIG. 3 shows a non-limiting example list priority view of the system 100. As shown in FIG. 3, there may be a list view of four priority categories, priority category 1 (302), priority category 2 (304), priority category 3 (306), and priority category 4 (308). The four priority categories of FIG. 3 are the same as the four priorities in FIG. 2. Priority category 1 (302) may present to a claim handler a list of all her claims that have been predicted and/or determined to be a priority of 1 by a machine learning model of the claim prioritization module 112, and/or its submodules, using the prediction methods described herein. The claim handler may click any of the claims in that category to work on them. Through this inventory view, priority may be applied to the claims themselves or to specific claim elements such as lifecycle fields and phone and/or email messages. As described above, a priority of category one may represent a priority assigned to the claim as a whole, or applied to the current lifecycle that the claim is involved in, or applied to the claim messages, or any other claim element. Claim prioritization module 112, and/or its submodules, may additionally track how the claim handler selects and/or sorts claims in this category view to train another machine learning model in order to track patterns and/or trends of how the claim handler is working on claims through this view. Once trained, such machine learning model may be applied to predict and/or determine an optimal view within this category to show the claim handler. For instance, a machine learning model may recognize that a certain claim handler typically picks business insurance claims in this category to work on before other types of insurance claims, and as such, a machine learning model of claim prioritization module 112, and/or its submodules, may be trained, and then applied, to predict and/or determine that this claim handler's view should be defaulted to show business claims first in this category, before other types of claims. However, if the claim handler is working on business claims at the expense of automotive claims and travel claims not being worked on, a machine learning model of claim prioritization module 112, and/or its submodules, may be trained, and then applied, to predict and/or determine that non-business claims should be prioritized ahead of some business claims so that the claim handler is working through and closing all types of claims assigned to her, not only business claims.

Priority category 2 (304) may present to a claim handler a list of all her claims that have been predicted and/or determined to be a priority of 2 by a machine learning model of the claim prioritization module 112, and/or its submodules. The claim handler may click any of the claims in that category to work on them. Through this inventory view, priority may be applied to the claims themselves or to specific claim elements such as lifecycle fields and phone and/or email messages. As described above, a priority of category two may represent a priority assigned to the claim as a whole, or applied to the current lifecycle that the claim is involved in, or applied to the claim messages, or any other claim elements. Claim prioritization module 112, and/or its submodules, may additionally track how the claim handler selects and/or sorts claims in this category view to train another machine learning model in order to track patterns and/or trends of how the claim handler is working on claims through this view. Once trained, such machine learning model may be applied to predict and/or determine an optimal view within this category to show the claim handler. For instance, a machine learning model may recognize that a certain claim handler typically selects the lifecycle claim element to drill into before any other claim element fields, and as such, a machine learning model of claim prioritization module 112, and/or its submodules, may be trained, and then applied, to predict and/or determine that this claim handler's view should be defaulted to show for each claim, in this category, lifecycle related elements first on the left before other claim elements which should be shown on the right, in an order such as CLAIM-LIFECYCLE-SLO-DEMAND-MESSAGES instead of, for instance, CLAIM-SLO-DEMAND-LIFECYCLE-MESSAGES.

Priority category 3 (306) may present to a claim handler a list of all her claims that have been predicted and/or determined to be a priority of 3 by a machine learning model of the claim prioritization module 112, and/or its submodules. The claim handler may click any of the claims in that category to work on them. Through this inventory view, priority may be applied to the claims themselves or to specific claim elements such as lifecycle fields and phone and/or email messages. As described above, a priority of category two may represent a priority assigned to the claim as a whole or applied to the current lifecycle that the claim is involved in, or applied to the claim messages. Claim prioritization module 112, and/or its submodules, may additionally track how the claim handler selects and/or sorts claims in this category view to train another machine learning model in order to track patterns and/or trends of how the claim handler is working on claim through this view. Once trained, such machine learning model may be applied to predict and/or determine an optimal view within this category to show the claim handler. For instance, a machine learning model may recognize that a certain claim handler typically selects the messages claim element to drill into before any other claim element fields, and as such, a machine learning model of claim prioritization module 112, and/or its submodules, may be trained, and then applied, to predict and/or determine that this claim handler's view should be defaulted to show for each claim, in this category, claim message related elements first on the left before other claim elements which should be shown on the right, in an order such as CLAIM-MESSAGES-LIFECYCLE-SLO-DEMAND instead of, for example, CLAIM-SLO-DEMAND-LIFECYCLE-MESSAGES.

Priority category 4 (308) may present to a claim handler a list of all her claims that have been predicted and/or determined to be a priority of 4 by a machine learning model of the claim prioritization module 112, and/or its submodules. The claim handler may click any of the claims in that category to work on them. Through this inventory view, priority may be applied to the claims themselves or to specific claim elements such as lifecycle fields and phone and/or email messages. As described above, a priority of category two may represent a priority assigned to the claim as a whole, or applied to the current lifecycle that the claim is involved in, or applied to the claim messages. Claim prioritization module 112, and/or its submodules, may additionally track how the claim handler selects and/or sorts claims in this category view to train another machine learning model in order to track patterns and/or trends of how the claim handler is working on claims through this view. Once trained, such machine learning model may be applied to predict and/or determine an optimal view within this category to show the claim handler. For instance, a machine learning model may recognize that a certain claim handler never selects the SLO claim element to drill into and always selects other claim element fields, and as such, a machine learning model of claim prioritization module 112, and/or its submodules, may be trained, and then applied, to predict and/or determine that this claim handler's view should be defaulted to show for each claim, in this category, the SLO claim element last on the right, after other claim elements which should be shown on the left, or not even shown in this view at all (possibly provided in a “more” link which lets the claim handler view and edit fields not shown directly in this view). The category view, at the instruction of the machine learning model, can be shown in an order such as CLAIM-MESSAGES-LIFECYCLE-DEMAND-SLO instead of, for instance, CLAIM-SLO-DEMAND-LIFECYCLE-MESSAGES. Additionally, the machine learning model may instruct the category view to not even show SLO such as CLAIM-MESSAGES-LIFCYCLE-DEMAND-more fields, where the messages fields may be provided in an additional subsidiary screen through a “more fields” link.

Refresh periodically 310 in FIG. 3 indicates that the machine learning models of this disclosure may be re-applied and predictions and/or determinations may be generated on a timed basis, or an ad-hoc basis. For instance, jobs may be schedule nightly to apply machine learning models to make predictions and/or determinations on newly closed claims to account for any training which could have been applied to those machine learning models throughout the day. Also, the system 100 may offer a claim handler the ability to ad-hoc apply machine learning models to make predictions and/or determinations on newly closed/completed claims.

FIG. 4 shows a non-limiting example calendar priority view of the system 100. As shown in FIG. 4, the example of four different priority categories described above can be shown in a calendar graphical user interface to a claim handler in order to incorporate viewing prioritized claims, and claim elements, in a calendar format if the claim handler prefers such user interface format. For this example, it is assumed that today's date is September 1^{st}. If priority 1 is predicted by machine learning model of claim prioritization module 112, and/or its submodules, to be worked on in the next three days then the calendar view may show the next three days of the calendar with a link to all claims with a priority of 1. Additionally, the machine learning model of claim prioritization module 112, and/or its submodules, may recognize that a particular claim handler works on priority 1 business insurance claims first before other priority 1 insurance claims, as such, when the machine learning model is applied, a prediction and/or determination may be made to show a link to priority 1 business insurance claims in the first of the three days where priority 1 claims are shown and the other non-business insurance claims in days two to three on the calendar.

In another example, if priority 2 is predicted by a machine learning model of claim prioritization module 112, and/or its submodules, to be worked on in the upcoming four to six days, then the calendar view may show the upcoming four to six days of the calendar with a link to all claims with a priority of 2. Also, if priority 3 is predicted by a machine learning model of claim prioritization module 112, and/or its submodules, to be worked on in the upcoming seven to ten days, then the calendar view may show the upcoming seven to ten days of the calendar with a link to all claims with a priority of 3. Lastly, if priority 4 is predicted by a machine learning model of claim prioritization module 112, and/or its submodules, to be worked on in 11 days and after, then the calendar view may show the upcoming 11 days and after of the calendar with a link to all claims with a priority of 4. As the specific claim handler changes her work patterns on processing claims, the machine learning models associated with this disclosure can be trained to take note of such change and be applied to modify the claim handler's user interference accordingly.

Refresh periodically 445 in FIG. 4 indicates that the machine learning models of this disclosure may be re-applied and predictions and/or determinations may be generated on a timed basis, or ad-hoc basis. For instance, jobs may be schedule nightly to apply machine learning models to make predictions and/or determinations on newly closed claims or even apply existing data set to a newly trained model for better predictions of existing data. Also, the system 100 may offer a claim handler the ability to ad-hoc apply machine learning models to make predictions and/or determinations on newly closed claims.

FIG. 5 shows a non-limiting example graph priority view of the system 100. As shown in FIG. 5, the four priority categories described above may be shown in a graph form to a claim handler. Each of the four priority categories described above may be represented on the graph as its own section of the graph and when a section is clicked, a claim handler may be brought to a view of the claim priority category selected. A machine learning model of claim prioritization module 112, and/or its submodules, may be trained to detect patterns and/or trends within this view in order to display prioritized claims in a view which encourages the claim handler to close claims quicker.

Refresh periodically 545 in FIG. 5 indicates that the machine learning models of this disclosure may be re-applied and predictions and/or determinations may be generated on a timed basis, or an ad-hoc basis. For instance, jobs may be schedule nightly to apply machine learning models to make predictions and/or determinations on newly closed claims. Also, the system 100 may offer a claim handler the ability to ad-hoc apply machine learning models to make predictions and/or determinations on newly closed claims.

FIG. 6 shows a non-limiting example inventory priority view 600 of the system 100. As shown in FIG. 6, a claim handler may view all the claims assigned to her in a list format. In this view, certain claim information may be presented to the claim handler so that the claim handler may decide which claim she works on next. A priority field may be presented with other claim information show the claim handler what priority the machine learning models of this disclosure rank a particular claim at. A machine learning model of claim prioritization module 112, and/or its submodules, may be trained to detect patterns and/or trends within this view in order to display prioritized claims in a view which encourages the claim handler to close claims quicker.

As shown in FIG. 6, inventory priority view 600 contains claim details section 602 and filtering section 604. Claim detail section 602 provides a claim handler a view of claim information such as claim number, risk profile, named insured, last reviewed date, demand number, time limit demand due date, follow-up date, claim insights, and CHIP tasks. Claim detail section 602 allows a claim handler to sort by any of the described fields in that section by clicking on the name of the field to toggle between ascending and descending ordering. Claim detail section 602 may have its fields updated and refreshed periodically to account for new predictions on claim priority and newly added claims associated with the claim handler. Filtering section 604 allows a claim handler to at least filter claim detail section 602 by time limit demands, demand follow ups, claim insights, and CHIP tasks. As can be seen from filtering section 604, a claim handler may select one or more filtering checkboxes to alter the claim data viewed in claim detail section 602.

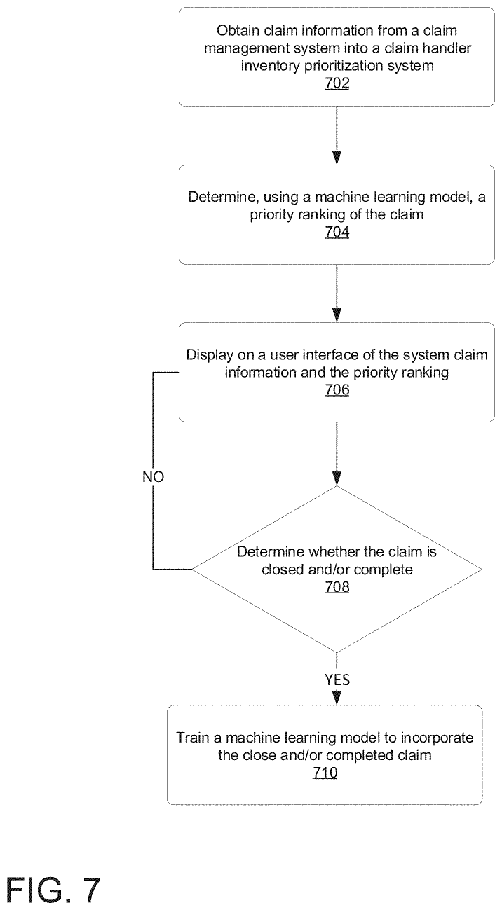

FIG. 7 shows a non-limiting example flowchart illustrating a method for determining system 100 claim priority and machine learning training. At block 702, the system 100 may obtain claim information from an external claim management system. The system 100 may convert the external fields into field formats that can be used and processed by the system 100. At block 704, the system 100 may take the received claim information and apply a trained machine learning model to predict a priority for the claim received. As described above, a priority may be applied to the whole claim, for example, the whole claim may be assigned, by a machine learning model, a priority number between 1 and 4. As also described above, a priority may be applied to elements of a claim to assist a claim handler in deciding on what elements of a claim to work on next. For instance, lifecycle elements of a claim may be predicted and/or determined by a machine learning model to make a suggestion to a claim handler that they should work on claims in a negotiation phase before claims in other lifecycle phases because a trend or pattern has been recognized by the machine learning model that claims in general would closed or be completed quicker if the claim handler works on claims in the negotiation phase first.

At block 706, after a machine learning model had predicted and/or determined priority, the system 100 may display the priority for the claim, or claim elements, on a user interface for a claim handler to see and process. As shown above, a claim handler may be provided with a categorial list view by priority of claims, or claim elements, where a machine learning model may be applied to how a claim handler works on and processes claims in that view. Prioritized claims, or claim elements, could also be displayed in a calendar view, where a machine learning model may be applied to how a claim handler works on and processes claims in that view. Prioritized claims, or claim elements, may also be displayed in a single inventory list view, where a machine learning model may be applied to how a claim handler works on and processes claims in that view, and then makes predictions and/or determinations based off of patterns and/or trends.

At block 708, the system 100 may evaluate whether the claim has been closed and/or completed. If the claim has been closed and/or completed by a claim handler then at block 710, the system 100 may train a machine learning model of claim prioritization module 112, or its submodules, with the completed claim to search for new patterns and/or trends gained from the newly completed claim.

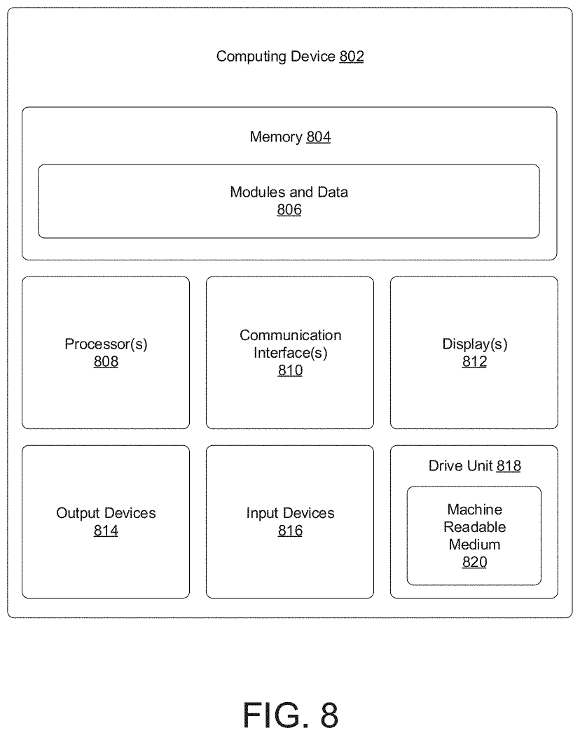

FIG. 8 shows an example system architecture for a computing device 802 associated with the system 100 described herein. A computing device 802 can be a server, computer, or other type of computing device that executes at least a portion of the system 100. In some examples, elements of the system 100 can be distributed among, and/or be executed by, multiple computing devices 802.

A computing device 802 can include memory 804. In various examples, the memory 804 can include system memory, which may be volatile (such as RAM), non-volatile (such as ROM, flash memory, etc.) or some combination of the two. The memory 804 can further include non-transitory computer-readable media, such as volatile and nonvolatile, removable and non-removable media implemented in any method or technology for storage of information, such as computer readable instructions, data structures, program modules, or other data. System memory, removable storage, and non-removable storage are all examples of non-transitory computer-readable media. Examples of non-transitory computer-readable media include, but are not limited to, RAM, ROM, EEPROM, flash memory or other memory technology, CD-ROM, digital versatile discs (DVD) or other optical storage, magnetic cassettes, magnetic tape, magnetic disk storage or other magnetic storage devices, or any other non-transitory medium which can be used to store desired information and which can be accessed by one or more computing devices 802 associated with the system 100. Any such non-transitory computer-readable media may be part of the computing devices 802.

The memory 804 can store modules and data 806. The modules and data 806 can include one or more of the claim prioritization module 112, claim inventory prioritization sub-module 114, claim lifecycle prioritization sub-module 116, or claim messages prioritization sub-module described above. Additionally, or alternately, the modules and data 806 can include any other modules and/or data that can be utilized by the system 100 to perform or enable performing any action taken by the system 100. Such other modules and data can include a platform, operating system, and applications, and data utilized by the platform, operating system, and applications.

One or more computing devices 802 of the system 100 can also have processor(s) 808, communication interfaces 810, displays 812, output devices 814, input devices 816, and/or a drive unit 818 including a machine readable medium 820.

In various examples, the processor(s) 808 can be a central processing unit (CPU), a graphics processing unit (GPU), both a CPU and a GPU, or any other type of processing unit. Each of the one or more processor(s) 808 may have numerous arithmetic logic units (ALUs) that perform arithmetic and logical operations, as well as one or more control units (CUs) that extract instructions and stored content from processor cache memory, and then executes these instructions by calling on the ALUs, as necessary, during program execution. The processor(s) 808 may also be responsible for executing computer applications stored in the memory 804, which can be associated with common types of volatile (RAM) and/or nonvolatile (ROM) memory.

The communication interfaces 810 can include transceivers, modems, interfaces, antennas, telephone connections, and/or other components that can transmit and/or receive data over networks, telephone lines, or other connections.

The display 812 can be a liquid crystal display or any other type of display commonly used in computing devices. For example, a display 812 may be a touch-sensitive display screen, and can then also act as an input device or keypad, such as for providing a soft-key keyboard, navigation buttons, or any other type of input.

The output devices 814 can include any sort of output devices known in the art, such as a display 812, speakers, a vibrating mechanism, and/or a tactile feedback mechanism. Output devices 814 can also include ports for one or more peripheral devices, such as headphones, peripheral speakers, and/or a peripheral display.

The input devices 816 can include any sort of input devices known in the art. For example, input devices 816 can include a microphone, a keyboard/keypad, and/or a touch-sensitive display, such as the touch-sensitive display screen described above. A keyboard/keypad can be a push button numeric dialing pad, a multi-key keyboard, or one or more other types of keys or buttons, and can also include a joystick-like controller, designated navigation buttons, or any other type of input mechanism.

The machine readable medium 820 can store one or more sets of instructions, such as software or firmware, that embodies any one or more of the methodologies or functions described herein. The instructions can also reside, completely or at least partially, within the memory 804, processor(s) 808, and/or communication interface(s) 810 during execution thereof by the one or more computing devices 802 of the system 100. The memory 804 and the processor(s) 808 also can constitute machine readable media 820.

Although the subject matter has been described in language specific to structural features and/or methodological acts, it is to be understood that the subject matter is not necessarily limited to the specific features or acts described above. Rather, the specific features and acts described above are disclosed as example embodiments.

What is claimed is:

1. A method, comprising:
obtaining, by a processor, claim information from a plurality of claim management systems;
determining, by the processor, a score based at least in part on the claim information;
generating, by the processor, a priority number for the insurance claim information, based at least in part on the score;
determining, by the processor, a preferred view of the claim information by a claim handler based at least in part on the priority number, wherein the preferred view may be a list view, calendar view, graph view, or inventory view; and
displaying, by the processor and via a display, the insurance claim information and the priority number via the preferred view.

2. The method of claim 1, wherein the score is determined using a machine learning model with a set of training data that comprises of closed insurance claims related to a single claim handler.

3. The method of claim 1, wherein the score is determined using a machine learning model with a set of training data that comprises of closed insurance claims related to claim handlers of an insurance company.

4. The method of claim 3, wherein the claim handlers of the insurance company are associated with the auto insurance department of the insurance company.

5. The method of claim 1, wherein the score is determined using a machine learning model with a set of training data set that comprises of closed insurance claims related to an insurance industry.

6. The method of claim 1, wherein the priority number is generated by identifying trends or patterns of how the claim handler processed email messages of closed claims via a machine learning model based on the claim information.

7. The method of claim 1, further comprising:
adding, by the processor, insurance claim information to a set of training data for a machine learning model when the insurance claim is closed; and
training, by the processor, the machine learning model by identifying trends or patterns identified within the set of training data.

8. A computing system, comprising:
one or more processors; and
memory storing computer-executable instructions that, when executed by the one or more processors, cause the computing system to perform operations comprising:
obtaining insurance claim information from a plurality of claim management systems;
determining a score based at least in part on the insurance claim information;
generating, a priority number for the insurance claim information, based at least in part on the score;
determining a preferred view of the insurance claim information by a claim handler based at least in part on the priority number, wherein the preferred view may be a list view, calendar view, graph view, or inventory view; and
displaying, via a display, the insurance claim information and the priority number via the preferred view.

9. The computing system of claim 8, wherein the score is further determined by identifying trends or patterns of how the claim handler processed phone messages associated with closed claims.

10. The computing system of claim 8, wherein the score is further determined by identifying trends or patterns of how quickly the claim handler finished a claim lifecycle task.

11. The computing system of claim 8, wherein a set of training data used in a machine learning model comprises of closed insurance claims related to a single claim handler.

12. The computing system of claim 8, wherein a set of training data used in a machine learning model comprises of closed insurance claims related to claim handlers of an insurance company department.

13. The computing system of claim 8, wherein a set of training data used in a machine learning model comprises of closed insurance claims related to claim handlers of an insurance company.

14. The computing system of claim 8, wherein the operations further comprise:
adding insurance claim information to a set of training data used in a machine learning model, when the insurance claim is closed; and
training the machine learning model by identifying trends or patterns identified within the set of training data.

15. One or more non-transitory computer-readable media storing computer-executable instructions that, when executed by one or more processors, cause the one or more processors to perform operations, comprising:
obtaining insurance claim information from a plurality of claim management systems;
determining a score based at least in part on the claim information;
generating, a priority number for the insurance claim information, based at least in part on the score;
determining a preferred view of claim information by a claim handler based at least in part on the priority number, wherein the preferred view may be a list view, calendar view, graph view, or inventory view; and
displaying, via a display, the insurance claim number and the priority number via the preferred view.

16. The one or more non-transitory computer-readable media of claim 15, wherein a set of training data used in a machine learning model comprises of closed insurance claims related to claim handlers of an insurance company.

17. The one or more non-transitory computer-readable media of claim 15, wherein a set of training data used in a machine learning model comprises of closed insurance claims related to an insurance industry.

18. The one or more non-transitory computer-readable media of claim 15, wherein the score is generated by identifying trends or patterns of how the claim handler processed phone messages associated with closed claims.

19. The one or more non-transitory computer-readable media of claim 15, wherein the score is generated by identifying trends or patterns of how the claim handler processed email messages associated with closed claims.

20. The one or more non-transitory computer-readable media of claim 15, wherein the operations further comprise:
adding, by the processor, insurance claim information to a set of training data used in a machine learning model when the insurance claim information is closed; and
training, by the processor, the machine learning model by identifying trends or patterns identified within the set of training data.
